(19) United States
(12) Patent Application Publication
(10) Pub. No.: US 2025/0023137 A1
(43) Pub. Date: Jan. 16, 2025

(54) BATTERY PACK

(71) Applicant: MURATA MANUFACTURING CO., LTD., Kyoto (JP)

(72) Inventor: Yoshiyuki BANNAI, Kyoto (JP)

(21) Appl. No.: 18/636,566

(22) Filed: Apr. 16, 2024

(30) Foreign Application Priority Data
Jul. 14, 2023 (JP) 2023-115697

(51) Int. Cl. H01M 10/653; H01M 50/213; H01M 50/291

(52) U.S. Cl. CPC H01M 10/653; H01M 50/213; H01M 50/291

(57) ABSTRACT

A battery pack is provided and includes: a plurality of batteries; a heat absorbing agent; a heat absorbing member that houses the heat absorbing agent; and a holder that holds the plurality of batteries and the heat absorbing member, in which the holder includes a holder member having a facing surface facing an outer surface of the heat absorbing member, the holder member is a porous body having continuous pores in which a plurality of pores are continuous, and at least one pore of the plurality of pores included in the continuous pores is opened in the facing surface.

### CROSS REFERENCE TO RELATED APPLICATIONS

The present application claims priority to Japanese patent application no. 2023-115697, filed on Jul. 14, 2023, the entire contents of which is incorporated herein by reference.

### BACKGROUND

The present disclosure relates to a battery pack.

As an example of a battery pack, a battery module including a heat absorbing member and a plurality of battery cells is provided. The heat absorbing member includes a heat absorbing agent and an exterior film enclosing the heat absorbing agent. At the time of abnormal heat generation of a secondary battery, an exterior film is cleaved, and the temperature of the secondary battery is lowered by the leaked heat absorbing agent.

### SUMMARY

The present disclosure relates to a battery pack.

However, there is a possibility that the heat absorbing agent flowing out from the exterior film remains at one place. In this case, a contact area between an outer surface of the secondary battery and the heat absorbing agent is relatively small, and heat absorption efficiency is relatively low.

The present disclosure has been made in view of the above, and the present disclosure relates to improving heat absorption efficiency of a heat absorbing agent at the time of abnormal heat generation of a battery in a battery pack according to an embodiment.

A battery pack of the present disclosure includes: a plurality of batteries; a heat absorbing agent; a heat absorbing member that houses the heat absorbing agent; and a holder that holds the plurality of batteries and the heat absorbing member, in which the holder includes a holder member having a facing surface facing an outer surface of the heat absorbing member, the holder member is a porous body having continuous pores in which a plurality of pores are continuous, and at least one pore of the plurality of pores included in the continuous pores is opened in the facing surface.

According to the present disclosure, it is possible to improve the heat absorption efficiency of the heat absorbing agent at the time of abnormal heat generation of the battery in the battery pack.

### BRIEF DESCRIPTION OF THE FIGURES

FIG. 1 is an exploded perspective view of a battery pack according to an embodiment of the present disclosure;

FIG. 2 is an exploded perspective view of a battery unit shown in FIG. 1;

FIG. 3 is a view showing a sectional shape of the battery unit shown in FIG. 1 taken along a plane orthogonal to a center axis of a battery;

FIG. 4 is a partially enlarged view of a sectional shape of the battery unit shown in FIG. 3;

FIG. 5 is a partially enlarged view of the sectional shape of the battery unit shown in FIG. 4;

FIG. 6 is a partially enlarged view of a sectional shape of the battery unit in the battery pack according to an embodiment of the present disclosure;

FIG. 7 is a partially enlarged view of a sectional shape of the battery unit in the battery pack according to an embodiment of the present disclosure;

FIG. 8 is a partially enlarged view of the sectional shape of the battery unit shown in FIG. 4 in the battery pack according to an embodiment of the present disclosure;

FIG. 9 is a partially enlarged view of a sectional shape of a battery unit in a battery pack according to a second embodiment of the present disclosure;

FIG. 10 is a partially enlarged view of a sectional shape of a battery unit in a battery pack according to an embodiment of the present disclosure;

FIG. 11 is a view showing a sectional shape of a battery unit in a battery pack according to an embodiment of the present disclosure;

FIG. 12 is a partially enlarged view of a sectional shape of a battery unit in a battery pack according to an embodiment of the present disclosure;

FIG. 13 is a perspective view of a battery unit in a battery pack according to an embodiment of the present disclosure;

FIG. 14 is a view showing a sectional shape of the battery unit shown in FIG. 13 taken along a plane orthogonal to an X direction;

FIG. 15 is a plan view of a battery shown in FIG. 14;

FIG. 16 is a perspective view of a battery unit according to an embodiment of the present disclosure; and

FIG. 17 is a view showing a sectional shape of the battery unit shown in FIG. 16 taken along a plane orthogonal to the X direction.

### DETAILED DESCRIPTION

Hereinafter, the present application will be described in further detail including with reference to the drawings. Note that the present disclosure is not limited to the embodiments. Each embodiment is illustrative, and it goes without saying that replacement and combination of a part of configurations shown in the different embodiments can be performed.

The X direction in the drawings corresponds to the width direction of the battery pack 1, the Y direction corresponds to the depth direction of the battery pack 1, and the Z direction corresponds to the height direction of the battery pack 1. The X direction, the Y direction, and the Z direction are orthogonal to each other. In the X direction, a side indicated by an arrow is defined as a +X side, and a side opposite to the +X side is defined as a −X side. In the Y direction, a side indicated by an arrow is defined as a +Y side, and a side opposite to the +Y side is defined as a −Y side. In the Z direction, a side indicated by an arrow is defined as a +Z side, and a side opposite to the +Z side is defined as a −Z side. Note that the X, Y, and Z directions are examples, and the present disclosure is not limited to these directions.

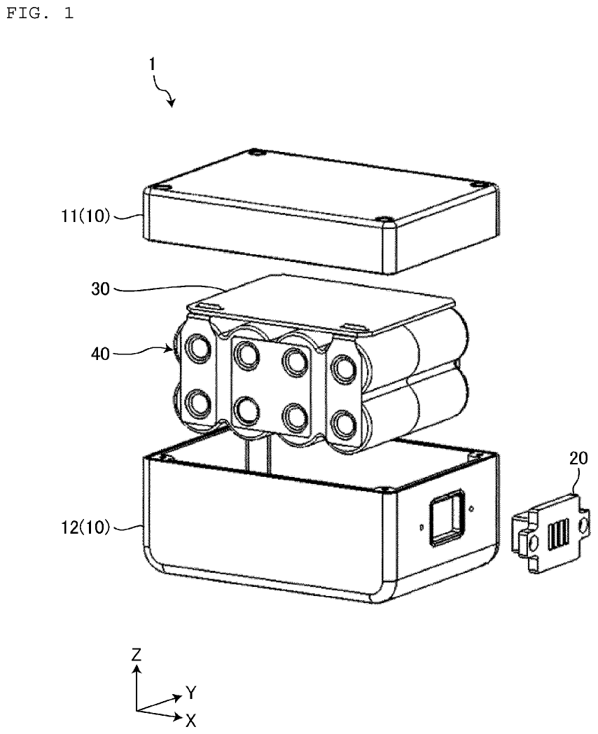

FIG. 1 is an exploded perspective view of a battery pack 1 according to a first embodiment of the present disclosure. The battery pack 1 can be applied as a power source to an external device (not illustrated) such as an electronic device, an electric vehicle, and an electric tool. The battery pack 1 includes an exterior case 10, a connector 20, a control board 30, and a battery unit 40.

The exterior case 10 has a box shape and houses the control board 30 and the battery unit 40. The exterior case 10 includes a first case portion 11 and a second case portion 12.

The connector 20 is attached to the exterior case 10. The connector 20 electrically connects an external device and the battery unit 40 via the control board 30, and supplies (discharges) power of the battery unit 40 to the external device. Further, the connector 20 electrically connects a power supply (for example, a commercial power supply) and the battery unit 40 via the control board 30, and supplies (charges) power from the power supply to the battery unit 40. The control board 30 controls charging and discharging of the battery unit 40.

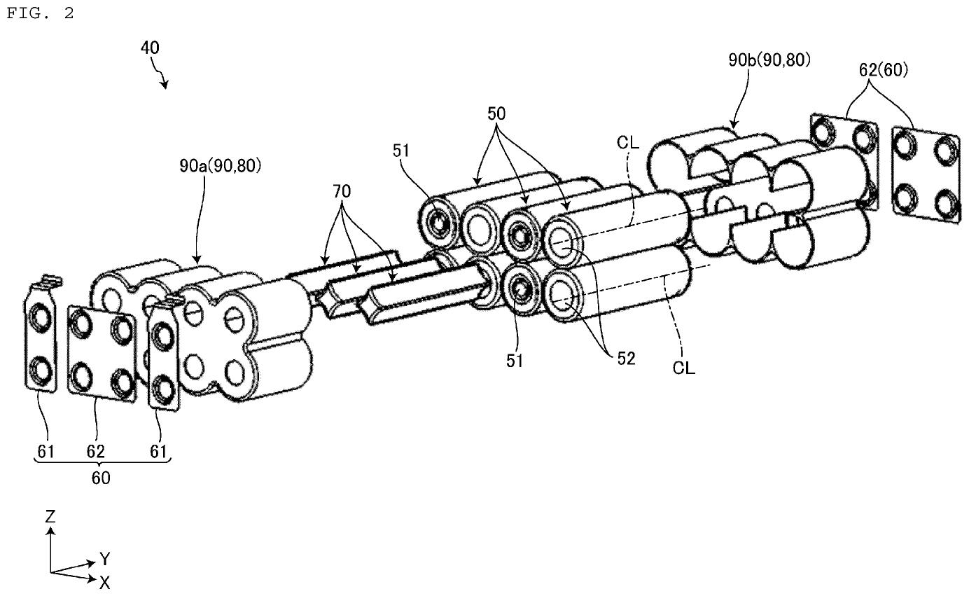

FIG. 2 is an exploded perspective view of the battery unit 40 shown in FIG. 1. The battery unit 40 includes a plurality of batteries 50, a plurality of lead plates 60, a plurality of heat absorbing members 70, and a holder 80.

The battery 50 is a secondary battery. The battery 50 is, for example, a lithium ion battery. The battery 50 has a cylindrical shape. In the first embodiment, the number of the batteries 50 is eight, but it goes without saying that the number is not limited to eight.

The plurality of batteries 50 are arranged in parallel in a state of spacing apart from each other. Center axes CL of the plurality of batteries 50 are parallel to each other. In the first embodiment, the center axis CL of the plurality of batteries 50 is along the Y direction. In the plurality of batteries 50, a direction of a positive electrode terminal 51 and a direction of a negative electrode terminal 52 are arranged in a predetermined direction.

The plurality of batteries 50 are arranged in two rows. Specifically, four batteries 50 are arranged along the X direction, and two batteries 50 are arranged along the Y direction. It goes without saying that the arrangement of the plurality of batteries 50 is not limited to two rows.

The lead plate 60 electrically connects the plurality of batteries 50 in series or in parallel. Furthermore, the lead plate 60 electrically connects the plurality of batteries 50 and the control board 30. The lead plate 60 includes a first lead plate 61 and a second lead plate 62. The first lead plate 61 electrically connects two of the batteries 50. The second lead plate 62 electrically connects four of the batteries 50. It goes without saying that the number of the batteries 50 electrically connected by the first lead plate 61 and the second lead plate 62 is not limited to the above numbers.

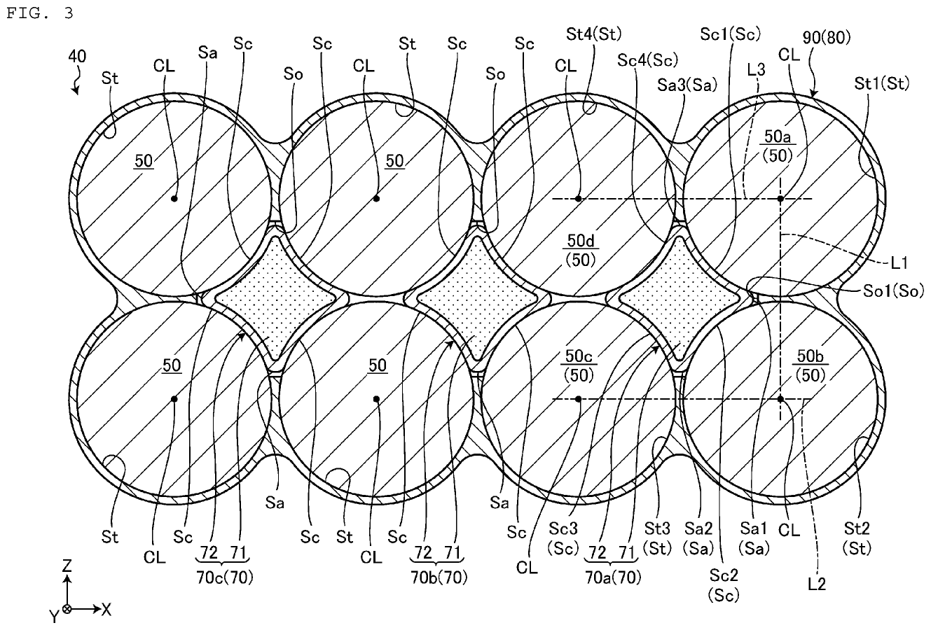

FIG. 3 is a view showing a sectional shape of the battery unit 40 shown in FIG. 1 taken along a plane orthogonal to the center axis CL of the battery 50.

As shown in FIGS. 2 and 3, the heat absorbing member 70 has a columnar shape. The sectional shape of the heat absorbing member 70 shown in FIG. 3 is a substantially quadrangular shape. The sectional shape of the heat absorbing member 70 may be a quadrangular shape. The heat absorbing member 70 is disposed so as to extend along the Y direction. The heat absorbing member 70 includes a heat absorbing agent 71 and an exterior member 72.

The heat absorbing agent 71 contains a substance that absorbs heat generated from the battery 50. The main component of the heat absorbing agent 71 is, for example, a liquid such as water. The heat absorbing agent 71 may contain a gelling agent, a surfactant, and an anti-freezing agent. The heat absorbing agent 71 has fluidity.

The exterior member 72 houses the heat absorbing member 70. An outer surface of the exterior member 72 corresponds to an outer surface of the heat absorbing member 70. The material of the exterior member 72 is, for example, a simple substance of polyethylene terephthalate. The material of the exterior member 72 may be a synthetic resin containing at least one of polyethylene terephthalate, polypropylene, polyethylene, and polystyrene.

In the present embodiment, the number of heat absorbing members 70 is three. It goes without saying that the number of heat absorbing members 70 is not limited to three. The plurality of heat absorbing members 70 are arranged in parallel along the X direction.

In the sectional shape shown in FIG. 3, each of the plurality of heat absorbing members 70 is surrounded by four of the plurality of batteries 50. Hereinafter, in order to simplify the description, the three heat absorbing members 70 are referred to as a first heat absorbing member 70a, a second heat absorbing member 70b, and a third heat absorbing member 70c in order from the +X side to the −X side. When the first heat absorbing member 70a, the second heat absorbing member 70b, and the third heat absorbing member 70c are described without distinction, they are simply referred to as the “heat absorbing member 70”.

In the sectional shape shown in FIG. 3, the four batteries 50 surrounding the first heat absorbing member 70a are referred to as a first battery 50a, a second battery 50b, a third battery 50c, and a fourth battery 50d. When the first battery 50a, the second battery 50b, the third battery 50c, and the fourth battery 50d are described without distinction, they are simply referred to as the “battery 50”.

The two first batteries 50a, the two second batteries 50b, the two third batteries 50c, and the two fourth batteries 50d are arranged along the X direction and along the Z direction. Specifically, among the first battery 50a, the second battery 50b, the third battery 50c, and the fourth battery 50d, the first battery 50a is disposed closest to the +Z side and closest to the +X side, and the first battery 50a, the second battery 50b, the third battery 50c, and the fourth battery 50d are arranged clockwise in FIG. 3 so as to surround the first heat absorbing member 70a in this order. The first heat absorbing member 70a is located between the first battery 50a and the third battery 50c and between the second battery 50b and the fourth battery 50d.

In the sectional shape shown in FIG. 3, an outer surface of first heat absorbing member 70a is in contact with each of an outer peripheral surface of the first battery 50a, an outer peripheral surface of the second battery 50b, an outer peripheral surface of the third battery 50c, and an outer peripheral surface of the fourth battery 50d. Specifically, the outer surface of the first heat absorbing member 70a has a first arcuate surface Sc1 in contact with the outer peripheral surface of the first battery 50a, a second arcuate surface Sc2 in contact with the outer peripheral surface of the second battery 50b, a third arcuate surface Sc3 in contact with the outer peripheral surface of the third battery 50c, and a fourth arcuate surface Sc4 in contact with the outer peripheral surface of the fourth battery 50d. Hereinafter, when the first arcuate surface Sc1, the second arcuate surface Sc2, the third arcuate surface Sc3, and the fourth arcuate surface Sc4 are described without distinction, they are simply referred to as the “arcuate surface Sc”. In the present specification, the arcuate surface Sc is a surface that is actually in contact with the outer peripheral surface of the battery 50, and a portion of the outer surface of the heat absorbing member 70 away from the outer peripheral surface of the battery 50 is not included in the arcuate surface Sc.

The outer surface of the heat absorbing member 70 has an opposing surface Sa facing a facing surface So described later. Specifically, the outer surface of the first heat absorbing member 70a has a first opposing surface Sa1 between the first arcuate surface Sc1 and the second arcuate surface Sc2, a second opposing surface Sa2 between the second arcuate surface Sc2 and the third arcuate surface Sc3, and a third opposing surface Sa3 between the fourth arcuate surface Sc4 and the first arcuate surface Sc1. Hereinafter, when the first opposing surface Sa1, the second opposing surface Sa2, and the third opposing surface Sa3 are described without distinction, they are simply referred to as the “opposing surface Sa”.

The outer surface of the second heat absorbing member 70b and the outer surface of the third heat absorbing member 70c have four arcuate surfaces Sc similarly to the first heat absorbing member 70a. The outer surface of the second heat absorbing member 70b has the two opposing surfaces Sa, and the outer surface of the third heat absorbing member 70c has the three opposing surfaces Sa similarly to the first heat absorbing member 70a. The positions and the number of the arcuate surfaces Sc and the opposing surfaces Sa on the outer surface of the heat absorbing member 70 differ depending on the number and arrangement of the batteries 50 and the heat absorbing members 70 in the battery unit 40.

As shown in FIGS. 2 and 3, the holder 80 holds the plurality of batteries 50 and the plurality of heat absorbing members 70. The holder 80 includes a first holder member 90a and a second holder member 90b.

The first holder member 90a holds the plurality of batteries 50 and the plurality of heat absorbing members 70 on the −Y side. The second holder member 90b holds the plurality of batteries 50 and the plurality of heat absorbing members 70 on the +Y side. The first holder member 90a and the second holder member 90b have the same shape. Hereinafter, when the first holder member 90a and the second holder member 90b are described without distinction, they are simply referred to as the “holder member 90”.

As shown in FIG. 3, the holder member 90 comes in contact with the plurality of batteries 50 to hold the plurality of batteries 50 and the plurality of heat absorbing members 70. First, a relationship between the holder member 90 and the first battery 50a, the second battery 50b, the third battery 50c, and the fourth battery 50d will be described.

An inner surface of the holder member 90 has a first contact surface St1, a second contact surface St2, a third contact surface St3, and a fourth contact surface St4 that are in contact with the outer surface of the first battery 50a, the outer surface of the second battery 50b, the outer surface of the third battery 50c, and the outer surface of the fourth battery 50d. In the sectional shape shown in FIG. 3, the first contact surface St1 is in contact with the outer peripheral surface of the first battery 50a, the second contact surface St2 is in contact with the outer peripheral surface of the second battery 50b, the third contact surface St3 is in contact with the outer peripheral surface of the third battery 50c, and the fourth contact surface St4 is in contact with the outer peripheral surface of the fourth battery 50d. Hereinafter, when the first contact surface St1, the second contact surface St2, the third contact surface St3, and the fourth contact surface St4 are described without distinction, they are simply referred to as “contact surfaces St”. In the present specification, the contact surface St is a surface that is actually in contact with the outer peripheral surface of the battery 50, and a portion of the inner surface of the holder member 90 away from the outer peripheral surface of the battery 50 is not included in the contact surface St.

The holder member 90 includes a portion overlapping a first imaginary line L1 connecting the center axes CL of the first battery 50a and the second battery 50b, a portion overlapping a second imaginary line L2 connecting the center axes CL of the second battery 50b and the third battery 50c, and a portion overlapping a third imaginary line L3 connecting the center axes CL of the fourth battery 50d and the first battery 50a.

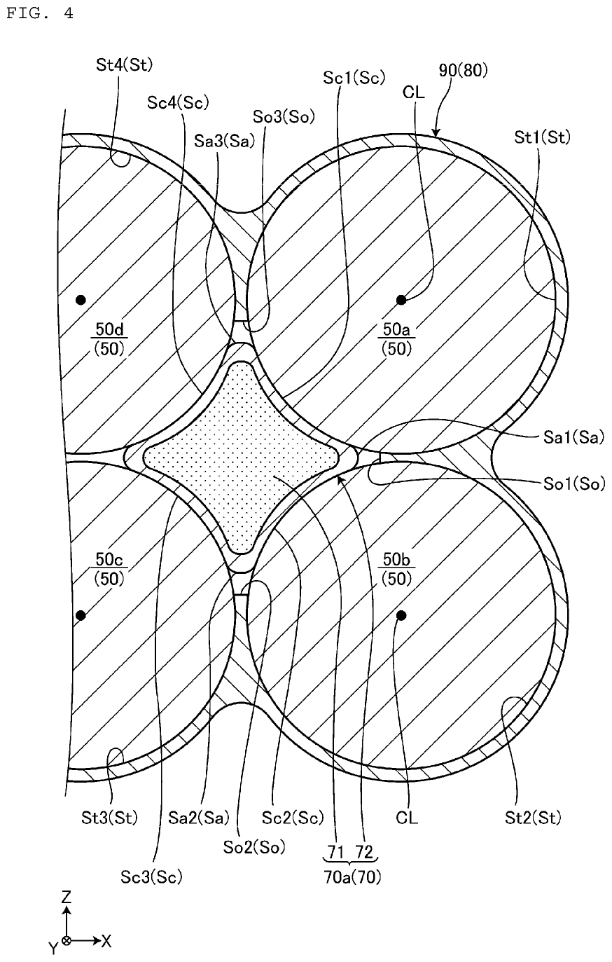

FIG. 4 is a partially enlarged view of the sectional shape of the battery unit 40 shown in FIG. 3. The inner surface of the holder member 90 further has the facing surface So facing the outer surface (specifically, the opposing surface Sa) of the heat absorbing member 70. The facing surface So is separated from the outer surface of the heat absorbing member 70. There are a plurality of the facing surfaces So.

In the sectional shape shown in FIG. 4, the facing surface So is located between the two batteries 50 adjacent to each other among the first battery 50a, the second battery 50b, the third battery 50c, and the fourth battery 50d. In the first embodiment, the inner surface of the holder member 90 has, in the sectional shape shown in FIG. 4, a first facing surface So1 between the first battery 50a and the second battery 50b, a second facing surface So2 between the second battery 50b and the third battery 50c, and a third facing surface So3 between the fourth battery 50d and the first battery 50a.

That is, in the sectional shape shown in FIG. 4, the first facing surface So1 is between the first contact surface St1 and the second contact surface St2. The second facing surface So2 is between the second contact surface St2 and the third contact surface St3. The third facing surface So3 is located between the fourth contact surface St4 and the first contact surface St1. The first facing surface So1 faces the first opposing surface Sa1. The second facing surface So2 faces the second opposing surface Sa2. The third facing surface So3 faces the third opposing surface Sa3. Hereinafter, when the first facing surface So1, the second facing surface So2, and the third facing surface So3 are described without distinction, they are simply referred to as the “facing surface So”.

As shown in FIG. 3, the inner surface of the holder member 90 further has a contact surface St in contact with the battery 50 other than the first battery 50a, the second battery 50b, the third battery 50c, and the fourth battery 50d. The inner surface of the holder member 90 further has the facing surface So facing the second heat absorbing member 70b and the third heat absorbing member 70c. The positions and the number of the contact surfaces St and the facing surfaces So on the inner surface of the holder member 90 differ depending on the number and arrangement of the batteries 50 and the heat absorbing members 70 in the battery unit 40.

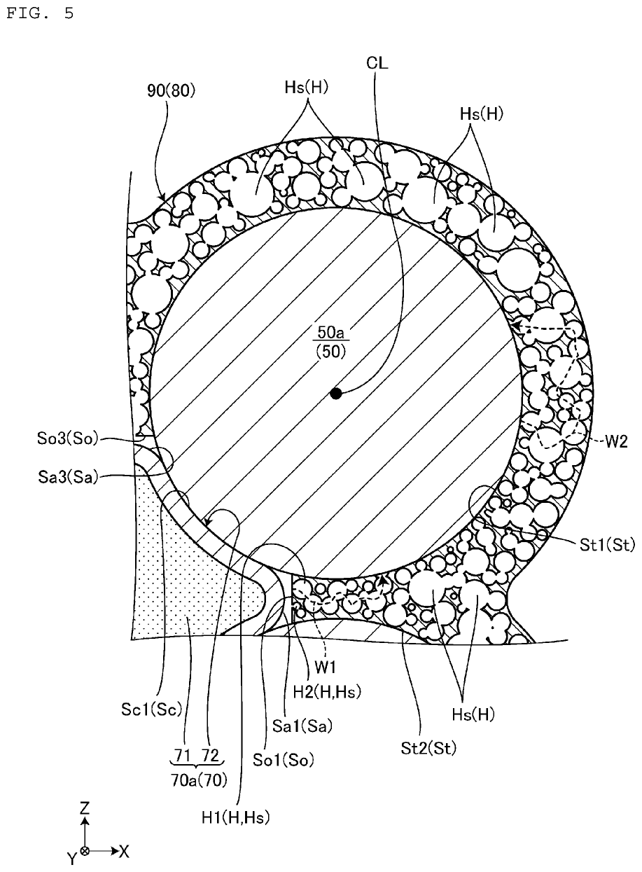

FIG. 5 is a partially enlarged view of the sectional shape of the battery unit 40 shown in FIG. 4. In FIG. 5, the thickness of the holder member 90 is illustrated to be larger than that in FIG. 4 in order to simplify the description.

The holder member 90 is a porous body of a continuous pore type. That is, the holder member 90 has continuous pores Hs in which a plurality of pores H are continuous. The material of the holder member 90 is foamed resin such as polyurethane and polystyrene. The material of the holder member 90 may be ceramic or metal. The holder member 90 has a heat insulating property by having the plurality of pores H.

The pores H and the continuous pores Hs exist in the entire holder member 90. As shown in FIG. 5, the plurality of pores H and the plurality of continuous pores Hs are provided in the holder member 90 so as to surround the battery 50 (the first battery 50a in FIG. 5). FIG. 5 is a sectional view of a predetermined portion of the battery unit 40, and the pores H that are not continuous in FIG. 5 may be continuous with pores not illustrated in FIG. 5. The continuous pores Hs are formed by connecting two or more pores H adjacent to each other in the radial direction or the circumferential direction of the battery 50 in the sectional shape shown in FIG. 5, or by connecting two or more pores H adjacent to each other in a direction along the center axis CL of the battery 50.

At least one of the pores H included in the continuous pores Hs is opened in the facing surface So. FIG. 5 shows pores H1 and H2 that are opened in the first facing surface So1 and included in the continuous pore Hs.

The holder member 90 includes a first communication path W1 and a second communication path W2. The first communication path W1 and the second communication path W2 are formed by the continuous pores Hs, and are flow paths through which the heat absorbing agent 71 can flow.

The first communication path W1 is a flow path having a first end opened to the facing surface So and a second end opened to the contact surface St. There are a plurality of the first communication paths W1. In the first communication path W1 shown in FIG. 5, the first end is opened to the first facing surface So1, and the second end is opened to the first contact surface St1. The pore H1 opened in the first facing surface So1 is included in the first communication path W1. The pore H2 is not included in the first communication path W1.

Needless to say, the facing surface So in which the first end of the first communication path W1 is opened is not limited to the first facing surface So1, and the contact surface St in which the second end of the first communication path W1 is opened is not limited to the first contact surface St1. The first communication path W1 branches between the first end and the second end, may have a third end opened to the same facing surface So as the facing surface So where the first end is opened, and may have a fourth end opened to the facing surface So different from the facing surface So where the first end is opened. Furthermore, the first communication path W1 may have a fifth end opened to the same contact surface St as the contact surface St where the second end is opened, and may have a sixth end opened to the contact surface St different from the contact surface St where the second end is opened.

The second communication path W2 is a flow path in which the first end and the second end are opened at different positions of the same contact surface St. There are a plurality of the second communication paths W2. In the second communication path W2 shown in FIG. 5, the first end and the second end are opened at different positions of the first contact surface St1.

It goes without saying that the contact surface St in which the first end and the second end of the second communication path W2 are opened is not limited to the first contact surface St1. The first end and the second end of the second communication path W2 may be opened to the contact surfaces St different from each other. In addition, the second communication path W2 branches between the first end and the second end, may have a third end opened to the same contact surface St as the contact surface St where the first end and the second end are opened, and may have a fourth end opened to the contact surface St different from the contact surface St where the first end and the second end are opened.

The outer surface of the holder member 90 is subjected to sealing hole treatment. The sealing hole treatment is, for example, coating. Examples of a coating material include urethane-based and acryl-based coating materials. A coating layer is formed on the outer surface of the holder member 90 by the sealing hole treatment. The coating layer covers the pore H opened in the outer surface of the holder member 90. That is, the pore H is not opened in the outer surface of the holder member 90.

Next, an operation of the battery pack 1 when the battery 50 abnormally generates heat will be described. The abnormal heat generation of the battery 50 is caused by, for example, a short circuit of the battery 50 or heating from the outside. Hereinafter, in order to simplify the description, a case where the first battery 50a abnormally generates heat will be described with reference to FIG. 5.

When the first battery 50a abnormally generates heat, the heat insulating property of the holder member 90 suppresses transfer of the heat of the first battery 50a to the battery 50 other than the first battery 50a. Thus, the abnormal heat generation of the battery 50 other than the first battery 50a can be suppressed.

Due to the abnormal heat generation of the first battery 50a, heat of the first battery 50a is transferred to the first heat absorbing member 70a. As a result, the temperature of the exterior member 72 of the first heat absorbing member 70a increases, and the exterior member 72 is cleaved, so that the heat absorbing agent 71 leaks out.

When the first arcuate surface Sc1 is cleaved, the heat absorbing agent 71 leaking from the first arcuate surface Sc1 comes into contact with the outer peripheral surface of the first battery 50a to absorb heat of the first battery 50a, and flows between the first arcuate surface Sc1 and the outer surface of the first battery 50a to reach the first facing surface So1 and the third facing surface So3.

When the first opposing surface Sa1 is cleaved, the heat absorbing agent comes into contact with the outer peripheral surface of the first battery 50a to absorb heat, and reaches the first facing surface So1. Similarly, when the second opposing surface Sa2 and the third opposing surface Sa3 are cleaved, the heat absorbing agent comes into contact with the outer peripheral surface of the first battery 50a to absorb heat, and reaches the second facing surface So2 and the third facing surface So3.

The heat absorbing agent 71 having reached the first facing surface So1 flows into the holder member 90 from the pore H1 opened in the first facing surface So1. The heat absorbing agent 71 spreads over a portion of the holder member 90 covering the first battery 50a through the continuous pores Hs. Thus, the heat absorbing agent 71 spreads around the first battery 50a without staying at one place, and absorbs heat of the first battery 50a. Therefore, heat absorption efficiency of the heat absorbing agent 71 can be improved.

The heat absorbing agent 71 flowing into the pore H1 flows through the first communication path W1, leaks from the first contact surface St1 in which the second end of the first communication path W1 is opened, and reaches the outer surface of the first battery 50a. That is, the heat absorbing agent 71 reaches a portion away from a portion in contact with the first heat absorbing member 70a on the outer surface of the first battery 50a, and absorbs heat of the first battery 50a. Therefore, the heat absorption efficiency of the heat absorbing agent 71 can be further improved.

In addition, the heat absorbing agent 71 having reached the outer surface of the first battery 50a through the first communication path W1 reaches the first end of the second communication path W2 opened at the first contact surface St1. The heat absorbing agent 71 leaks from the second end of the second communication path W2 opened at the first contact surface St1 through the second communication path W2. In the first contact surface St1, the second end of the second communication path W2 is away from the second end of the first communication path W1. Thus, the heat absorbing agent 71 reaches a relatively wide region on the outer surface of the first battery 50a, and absorbs heat of the first battery 50a. Therefore, the heat absorption efficiency of the heat absorbing agent 71 can be further improved.

The heat absorbing agent 71 having reached the second facing surface So2 and the third facing surface So3 also absorbs heat of the first battery 50a similarly to the heat absorbing agent 71 having reached the first facing surface So1. Also when the battery 50 other than the first battery 50a abnormally generates heat, heat of the battery 50 is absorbed by the heat absorbing agent 71 leaking from the heat absorbing member 70 similarly to the case where the first battery 50a abnormally generates heat. Accordingly, it is possible to improve the heat absorption efficiency of the heat absorbing agent 71 at the time of abnormal heat generation of the battery 50 in the battery pack 1.

Next, the battery pack 1 according to a modification of the first embodiment of the present disclosure will be described mainly with respect to portions different from those of the first embodiment.

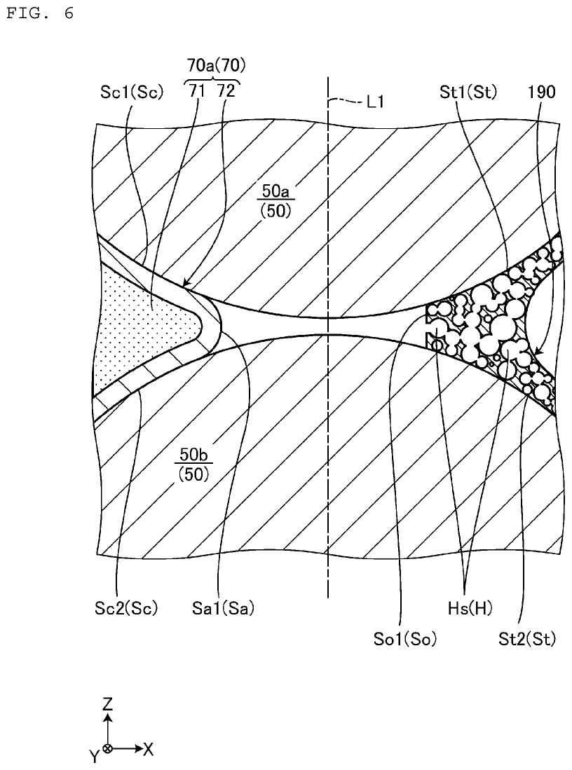

FIG. 6 is a partially enlarged view of a sectional shape of the battery unit 40 in the battery pack 1 according to a first modification of the first embodiment of the present disclosure. The sectional shape of the battery unit 40 shown in FIG. 6 is a sectional shape taken along a plane orthogonal to the center axis CL of the battery 50. The battery unit 40 of the first modification differs from the battery unit 40 of the first embodiment in the shape of a holder member 190.

The holder member 190 of the first modification does not have a portion overlapping the first imaginary line L1 connecting the center axes CL of the first battery 50a and the second battery 50b in the sectional shape shown in FIG. 6. That is, the holder member 190 is located at a position deviated from the first imaginary line L1 in the sectional shape shown in FIG. 6.

In the first modification, as compared with the case where the holder member 90 has the portion overlapping the first imaginary line L1 when the first battery 50a abnormally generates heat, the heat absorbing agent 71 leaking from the first opposing surface Sa1 early reaches a portion (portion overlapping the first imaginary line L1 in a space surrounded by the heat absorbing member 70, the first battery 50a, the second battery 50b, and the holder member 190 shown in FIG. 6) where a distance between the outer peripheral surface of the first battery 50a and the outer peripheral surface of the second battery 50b is the shortest. The heat absorbing agent 71 fills a space between the first battery 50a and the second battery 50b. The portion where the distance between the outer peripheral surface of the first battery 50a and the outer peripheral surface of the second battery 50b is the shortest is most likely to transfer heat between the batteries 50a and 50b. Thus, by causing the heat absorbing agent 71 to early reach and fill the portion where the distance between the outer peripheral surface of the first battery 50a and the outer peripheral surface of the second battery 50b is the shortest, heat of the first battery 50a can be further suppressed from being transmitted to the second battery 50b. Since the holder member 190 is located away from the first imaginary line L1, a part of the outer surface of the first battery 50a is exposed from the holder member 190 (see FIG. 6). As a result, the heat absorbing agent 71 is early transferred to the outer surface of the first battery 50a, and early absorbs heat of the first battery 50a.

In addition, the heat absorbing agent 71 leaking from the first opposing surface Sa1 early reaches the first facing surface So1, early spreads over the holder member 190 through the continuous pores Hs, and absorbs heat of the first battery 50a similarly to the first embodiment. Thus, the heat absorbing agent 71 early absorbs heat of the first battery 50a. Therefore, the heat absorption efficiency of the heat absorbing agent 71 can be further improved.

Also when the holder member 190 does not have a portion overlapping the imaginary line connecting the center axes CL of the two batteries 50 among the plurality of batteries 50, the heat absorption efficiency of the heat absorbing agent 71 can be further improved similarly to the case where the holder member 190 has a portion overlapping the first imaginary line L1.

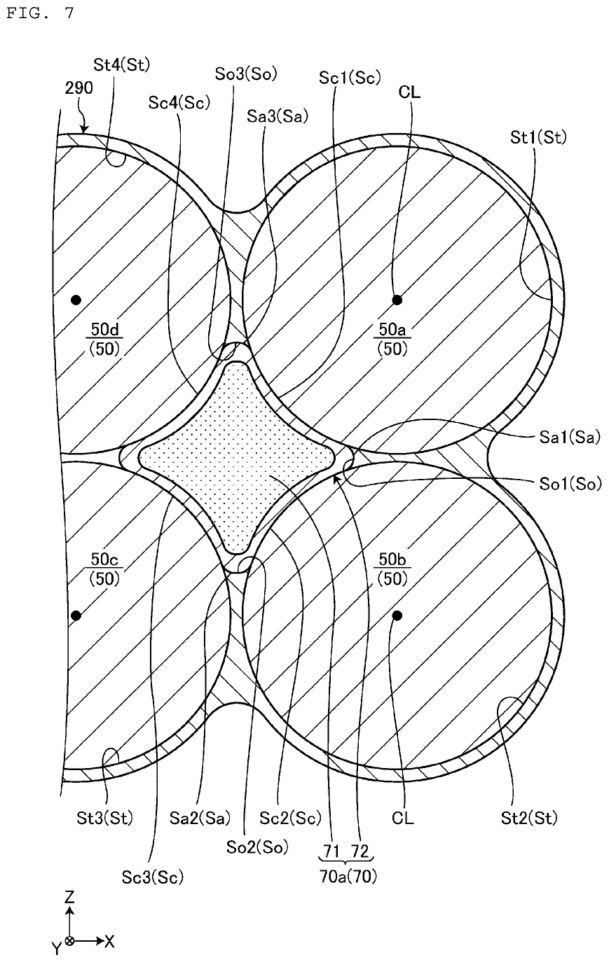

FIG. 7 is a partially enlarged view of a sectional shape of the battery unit 40 in the battery pack 1 according to a second modification of the first embodiment of the present disclosure. The sectional shape of the battery unit 40 shown in FIG. 7 is the sectional shape taken along the plane orthogonal to the center axis CL of the battery 50.

The battery unit 40 of the second modification is different from that of the first embodiment in that the facing surface So of a holder member 290 is in contact with the outer surface of the heat absorbing member 70 in the sectional shape shown in FIG. 7. Specifically, the facing surface So is in contact with the opposing surface Sa.

As a result, the heat absorbing agent 71 leaking from the first opposing surface Sa1 early reaches the first facing surface So1, early spreads over the holder member 290 through the continuous pores Hs, and absorbs heat of the first battery 50a similarly to the first embodiment. Thus, the heat absorbing agent 71 early absorbs heat of the first battery 50a. Therefore, the heat absorption efficiency of the heat absorbing agent 71 can be further improved.

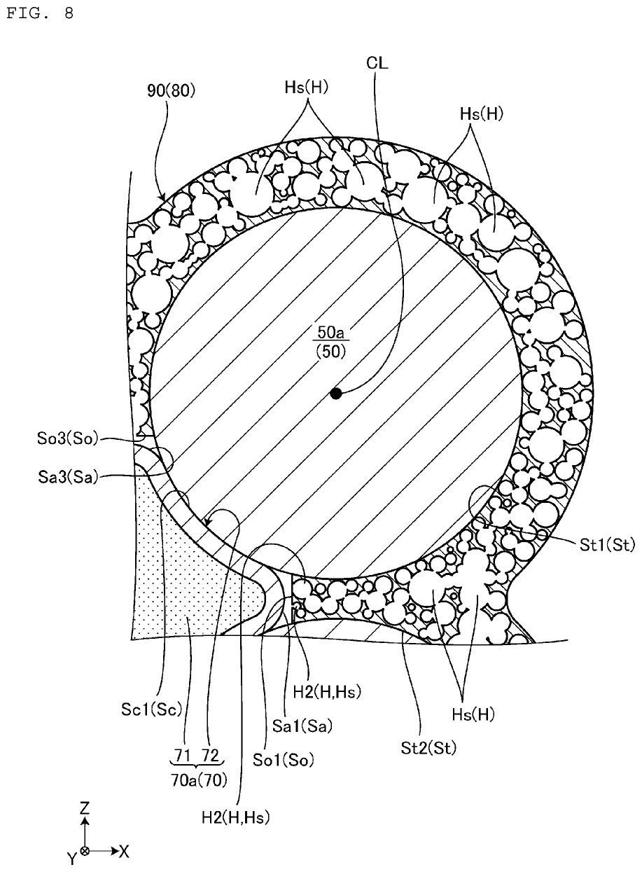

FIG. 8 is a partially enlarged view of the sectional shape of the battery unit 40 shown in FIG. 4 in the battery pack 1 according to a third modification of the first embodiment of the present disclosure. In FIG. 8, the thickness of the holder member 90 is illustrated to be larger than that in FIG. 4 in order to simplify the description.

In the third modification, the holder member 90 does not include the first communication path W1 and the second communication path W2. On the other hand, in the holder member 90 according to the third modification, the pores H and the continuous pores Hs exist in the entire holder member 90, similarly to the holder member 90 of the first embodiment. The pore H2 opened in the first facing surface So1 shown in FIG. 8 is included in the continuous pore Hs, and is not included in the first communication path W1. That is, if the continuous pores Hs are traced from the pore H2, the continuous pores Hs do not reach the outer surface of the battery 50. In the third modification, since the pore H included in the second communication path W2 is not provided, if the pores H opened in the contact surface St in contact with the outer surface of the battery 50 are traced, the pores H do not reach the other pores H opened in the contact surface St. In the third modification, the heat absorbing agent 71 that has leaked from the heat absorbing member 70 and reached the facing surface So at the time of abnormal heat generation of the battery 50 flows into the holder member 90 from the pore H2 opened in the facing surface So, and spread over a portion of the holder member 90 covering the battery 50 through the continuous pore Hs. Therefore, the heat absorbing agent 71 spreads around the battery 50 without staying at one place, and absorbs heat of the battery 50. As described above, in the third modification, if the heat absorbing agent 71 does not reach the outer surface of the battery 50, the heat absorbing agent 71 absorbs heat of the battery 50 by spreading around the battery 50. Therefore, heat absorption efficiency of the heat absorbing agent 71 can be improved.

Next, a battery pack 1 according to a second embodiment of the present disclosure will be described mainly with respect to portions different from those of the first embodiment.

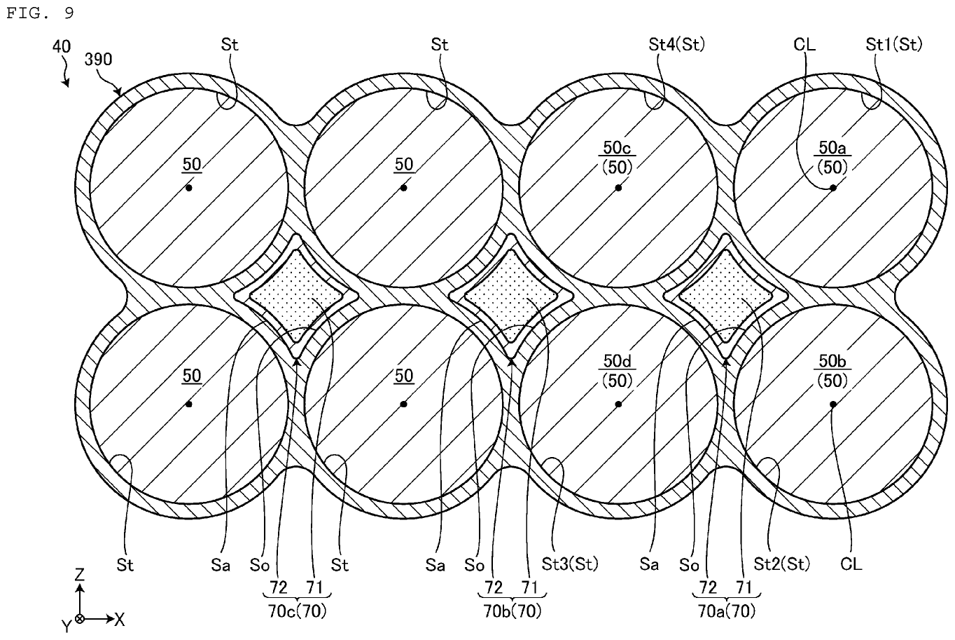

FIG. 9 is a partially enlarged view of a sectional shape of a battery unit 40 in the battery pack 1 according to the second embodiment of the present disclosure. The sectional shape of the battery unit 40 shown in FIG. 9 is the sectional shape taken along the plane orthogonal to a center axis CL of a battery 50.

The battery unit 40 of the second embodiment is different from that of the first embodiment in that, in the sectional shape shown in FIG. 9, an inner surface of a holder member 390 is in contact with outer peripheral surfaces of a plurality of the batteries 50 including a first battery 50a, a second battery 50b, a third battery 50c, and a fourth battery 50d and outer peripheral surfaces of a plurality of heat absorbing members 70 over the entire circumference. The thickness of the holder member 390 is substantially constant.

Specifically, the battery 50 and the heat absorbing member 70 are not in contact with each other, and the holder member 390 is located also between the battery 50 and the heat absorbing member 70. A contact surface St is in contact with the entire circumference of the outer peripheral surface of the battery 50. That is, a first contact surface St1 is in contact with the outer peripheral surface of the first battery 50a over the entire circumference. A second contact surface St2 is in contact with the outer peripheral surface of the second battery 50b over the entire circumference. A third contact surface St3 is in contact with the outer peripheral surface of the third battery 50c over the entire circumference. A fourth contact surface St4 is in contact with the outer peripheral surface of the fourth battery 50d over the entire circumference.

In the sectional shape shown in FIG. 9, the facing surface So is in contact with the outer peripheral surface of the heat absorbing member 70 over the entire circumference. In the sectional shape shown in FIG. 9, the outer peripheral surface of the heat absorbing member 70 in contact with the facing surface So corresponds to the opposing surface Sa.

As a result, the heat absorbing agent 71 leaking from the outer surface of the heat absorbing member 70 early reaches the facing surface So, early spreads over the holder member 390 through continuous pores Hs, and absorbs heat of the battery 50 similarly to the first embodiment. Thus, the heat absorbing agent 71 early absorbs heat of the battery 50. Therefore, the heat absorption efficiency of the heat absorbing agent 71 can be further improved.

The holder member 90 holds the plurality of batteries 50 in contact with the entire circumference of the outer peripheral surface of the battery 50. Thus, when one battery 50 abnormally generates heat, it is possible to further suppress heat transfer to the other batteries 50.

In addition, in the second embodiment, the holder member 90 individually holds the plurality of batteries 50 and the plurality of heat absorbing members 70. Thus, rigidity of a holder 80 can be improved. Therefore, the vibration resistance and impact resistance of the battery unit 40 can be improved.

Next, a battery pack 1 according to a third embodiment of the present disclosure will be described mainly with respect to portions different from those of the first embodiment.

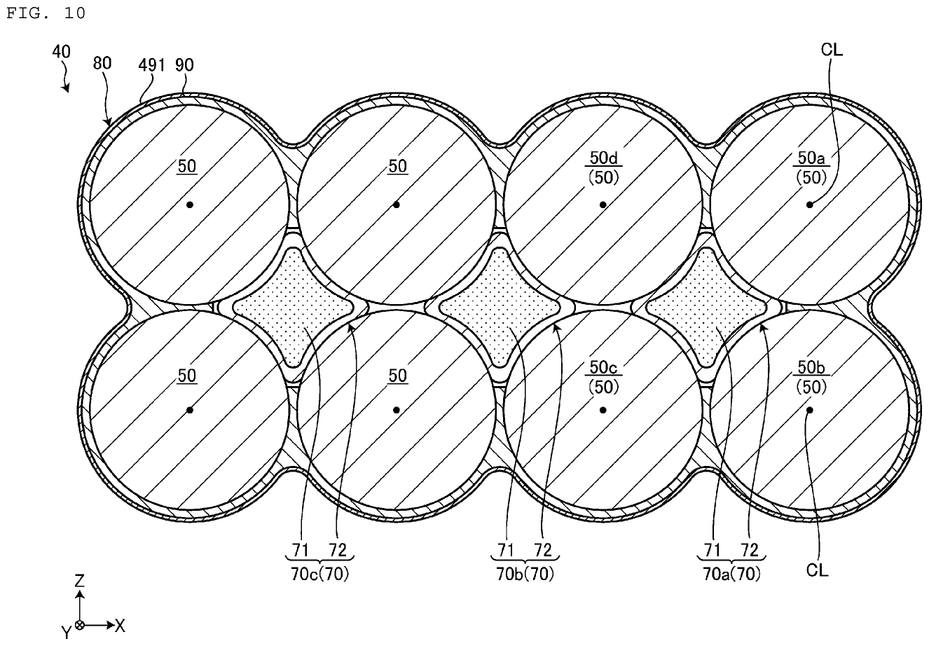

FIG. 10 is a partially enlarged view of a sectional shape of a battery unit 40 in the battery pack 1 according to the third embodiment of the present disclosure. The sectional shape of the battery unit 40 shown in FIG. 10 is the sectional shape taken along the plane orthogonal to a center axis CL of a battery 50.

In the battery unit 40 of the third embodiment, the holder 80 further includes an outer layer 491 disposed on the outer surface of the holder member 90. The outer surface of the holder member 90 of the third embodiment is not subjected to sealing hole treatment.

The outer layer 491 covers a pore H opened in the outer surface of the holder member 90 among the plurality of pores H, and has rigidity higher than the rigidity of the holder member 90. The material of the outer layer 491 is a thermoplastic resin, and is, for example, polyurethane, polystyrene, polycarbonate, polyamide, or the like. The material of the outer layer 491 may be ceramic and metal.

As a result, the rigidity of the holder 80 can be reliably improved. Therefore, the vibration resistance and impact resistance of the battery unit 40 can be reliably improved. Since the rigidity can be secured when the holder member 90 is made thin, the downsizing and weight reduction of the battery unit 40 can be achieved.

Next, a battery pack 1 according to a fourth embodiment of the present disclosure will be described mainly with respect to portions different from those of the first embodiment.

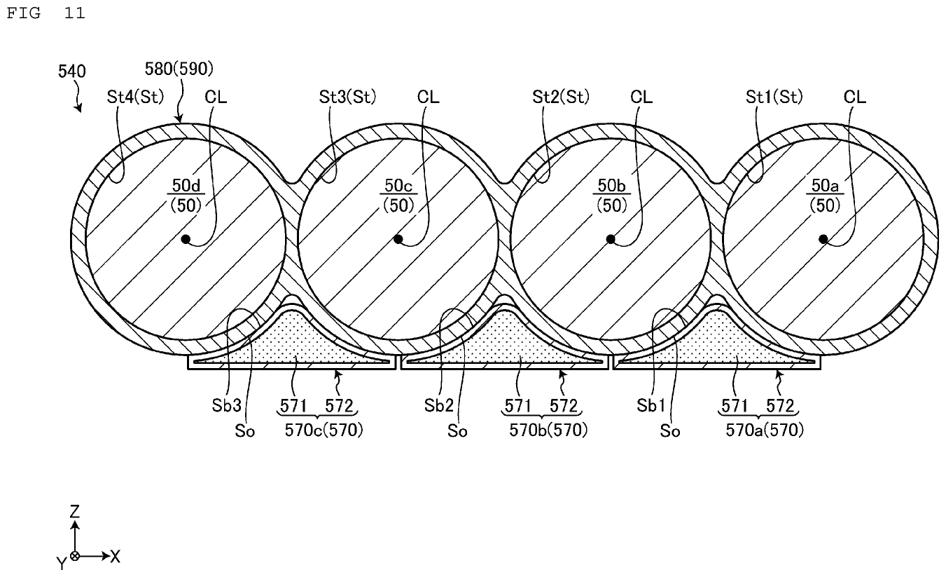

FIG. 11 is a view showing a sectional shape of a battery unit 540 in the battery pack 1 according to the fourth embodiment of the present disclosure. The sectional shape of the battery unit 540 shown in FIG. 11 is the sectional shape taken along the plane orthogonal to a center axis CL of a battery 50.

The battery unit 540 of the fourth embodiment is different from that of the first embodiment in that a plurality of the batteries 50 are arranged in a row along a direction (specifically, the X direction) orthogonal to the center axis CL. In the fourth embodiment, the plurality of batteries 50 are referred to as a first battery 50a, a second battery 50b, a third battery 50c, and a fourth battery 50d in order from the +X side to the −X side. The shapes of a holder 580 (holder member 590) and a heat absorbing member 570 are different from those of the first embodiment. The heat absorbing member 570 includes a heat absorbing agent 571 and an exterior member 572.

In the fourth embodiment, in the sectional shape shown in FIG. 11, a first contact surface St1 is in contact with the outer peripheral surface of the first battery 50a over the entire circumference, a second contact surface St2 is in contact with the outer peripheral surface of the second battery 50b over the entire circumference, a third contact surface St3 is in contact with the outer peripheral surface of the third battery 50c over the entire circumference, and a fourth contact surface St4 is in contact with the outer peripheral surface of the fourth battery 50d over the entire circumference. The thickness of the holder member 590 is substantially constant.

The heat absorbing member 570 is disposed on the −Z side of the plurality of batteries 50. When the battery unit 540 is viewed from the +Z side along the Z direction, the first heat absorbing member 570a overlaps the first battery 50a and the second battery 50b, the second heat absorbing member 570b overlaps the second battery 50b and the third battery 50c, and the third heat absorbing member 570c overlaps the third battery 50c and the fourth battery 50d.

In the sectional shape shown in FIG. 11, the +Z-side outer surface of the first heat absorbing member 570a has a first curved surface Sb1 in contact with the outer surface of the holder member 590. When the battery unit 540 is viewed from the +Z side along the Z direction, the first curved surface Sb1 overlaps the first battery 50a and the second battery 50b. A portion of the outer surface of the holder member 590 in contact with the first curved surface Sb1 corresponds to a facing surface So. The facing surface So in contact with the first curved surface Sb1 is on the opposite side of the first contact surface St1 and the second contact surface St2 in the holder member 590. The −Z-side outer surface of the first heat absorbing member 570a is a plane orthogonal to the Z direction.

In the sectional shape shown in FIG. 11, the +Z-side outer surface of the second heat absorbing member 570b has a second curved surface Sb2 in contact with the outer surface of the holder member 590. When the battery unit 540 is viewed from the +Z side along the Z direction, the second curved surface Sb2 overlaps the second battery 50b and the third battery 50c. A portion of the outer surface of the holder member 590 in contact with the second curved surface Sb2 corresponds to the facing surface So. The facing surface So in contact with the second curved surface Sb2 is on the opposite side of the second contact surface St2 and the third contact surface St3 in the holder member 590. The −Z-side outer surface of the second heat absorbing member 570b is a plane orthogonal to the Z direction.

In addition, in the sectional shape shown in FIG. 11, the +Z-side outer surface of the third heat absorbing member 570c has a third curved surface Sb3 in contact with the outer surface of the holder member 590. When the battery unit 540 is viewed from the +Z side along the Z direction, the third curved surface Sb3 overlaps the third battery 50c and the fourth battery 50d. A portion of the outer surface of the holder member 590 in contact with the third curved surface Sb3 corresponds to the facing surface So. The facing surface So in contact with the third curved surface Sb3 is on the opposite side of the third contact surface St3 and the fourth contact surface St4 in the holder member 590. The-Z-side outer surface of the third heat absorbing member 570c is a plane orthogonal to the Z direction.

In the battery unit 540 of the fourth embodiment, the heat absorbing agent 571 leaking from the first curved surface Sb1, the second curved surface Sb2, and the third curved surface Sb3 early reaches the facing surface So, early spreads over the holder member 590 through the continuous pores Hs, and absorbs heat of the battery 50 similarly to the first embodiment. Thus, the heat absorbing agent 571 early absorbs heat of the battery 50. Therefore, the heat absorption efficiency of the heat absorbing agent 571 can be further improved.

Next, a battery pack 1 according to a fifth embodiment of the present disclosure will be described mainly with respect to portions different from those of the first embodiment.

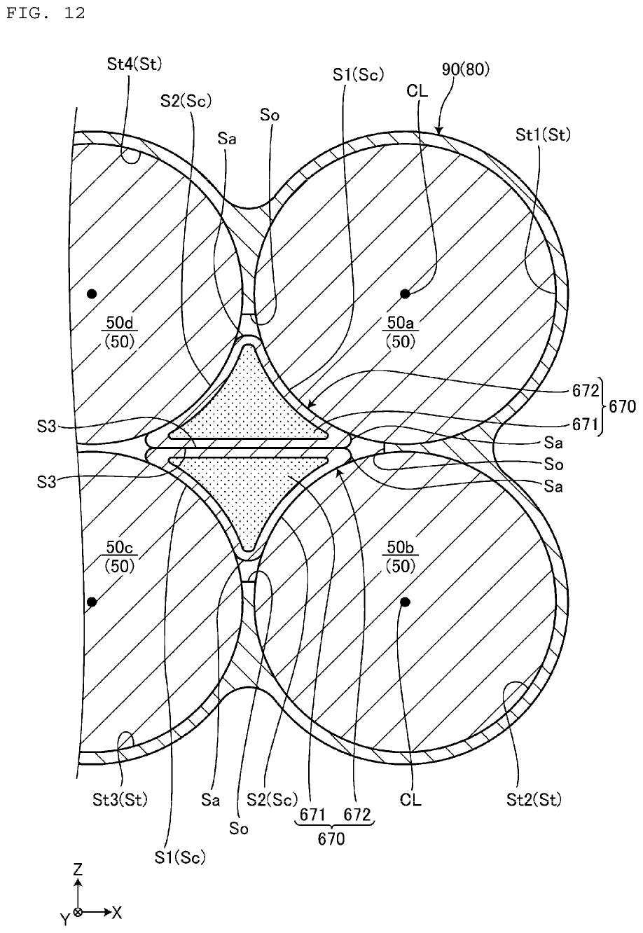

FIG. 12 is a partially enlarged view of a sectional shape of a battery unit 40 in the battery pack 1 according to the fifth embodiment of the present disclosure. The sectional shape of the battery unit 40 shown in FIG. 12 is the sectional shape taken along the plane orthogonal to a center axis CL of a battery 50.

The battery unit 40 of the fifth embodiment is different from that of the first embodiment in that the four batteries 50 surround two heat absorbing members 670 in the sectional shape shown in FIG. 12. The two heat absorbing members 670 are arranged in a state of being in contact with each other along the Z direction.

In the heat absorbing member 670 of the fifth embodiment, the shape of an exterior member 672 housing the heat absorbing agent 671 is different from that of the exterior member 72 of the first embodiment. Specifically, an outer surface of the exterior member 672 (that is, an outer surface of the heat absorbing member 670) has a first surface S1, a second surface S2, and a third surface S3. The first surface S1 and the second surface S2 are curved surfaces. The third surface S3 is a flat surface. The outer surface of the exterior member 672 has a substantially triangular shape in the sectional shape shown in FIG. 12.

Of the two heat absorbing members 670, the heat absorbing member 670 on the +Z side is in contact with an outer peripheral surface of a first battery 50a on the first surface S1, and is in contact with an outer peripheral surface of a fourth battery 50d on the second surface S2. Of the two heat absorbing members 670, the heat absorbing member 670 on the −Z side is in contact with an outer peripheral surface of a second battery 50b on the second surface S2, and is in contact with an outer peripheral surface of a third battery 50c on the first surface S1. That is, the first surface S1 and the second surface S2 correspond to an arcuate surface Sc. In the two heat absorbing members 670, the third surfaces S3 are in contact with each other.

In the heat absorbing member 670 of the fifth embodiment, the heat absorbing agent 671 leaking from an opposing surface Sa absorbs heat of the battery 50 similarly to the first embodiment. Therefore, the heat absorption efficiency of the heat absorbing agent 671 can be improved.

Next, a battery pack 1 according to a sixth embodiment of the present disclosure will be described mainly with respect to portions different from those of the first embodiment.

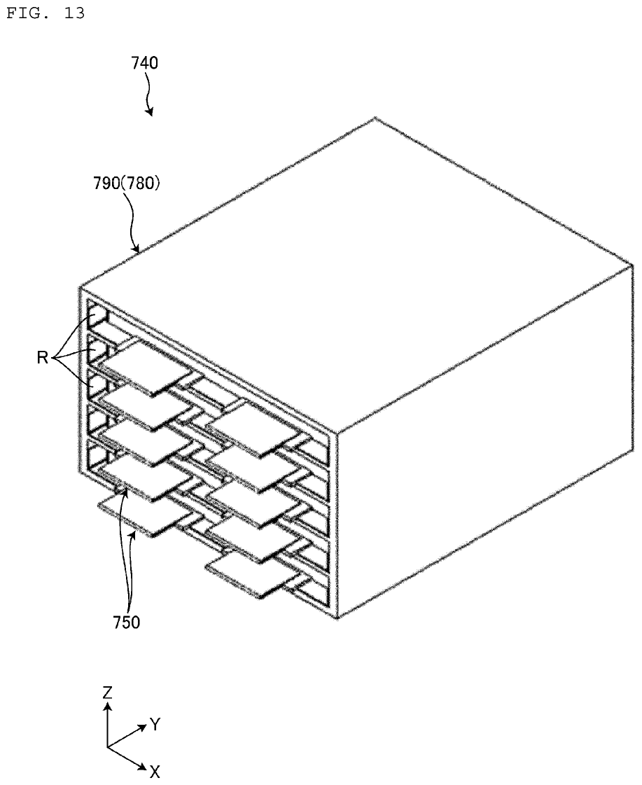

FIG. 13 is a perspective view of a battery unit 740

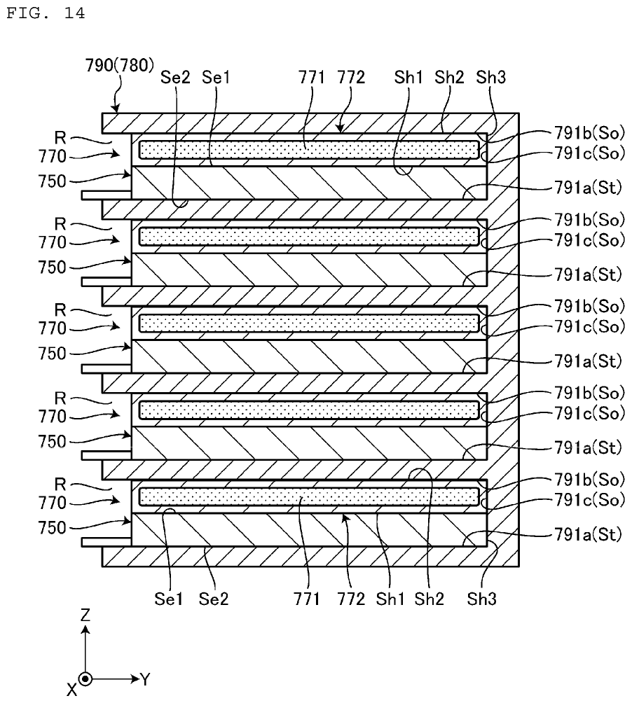

in the battery pack 1 according to the sixth embodiment of the present disclosure. FIG. 14 is a view showing a sectional shape of the battery unit 740 shown in FIG. 13 taken along a plane orthogonal to the X direction.

In the battery unit 740 of the sixth embodiment, the type of the battery 750, the shape of the heat absorbing member 770, and the shape of the holder 780 are mainly different from those of the first embodiment. The battery unit 740 of the sixth embodiment includes a plurality of batteries 750, a plurality of heat absorbing members 770, and a holder 780. In the sixth embodiment, the number of the batteries 750 is five, and the number of the heat absorbing members 770 is five. It goes without saying that the number of batteries 750 and the number of heat absorbing members 770 are not limited to the above numbers.

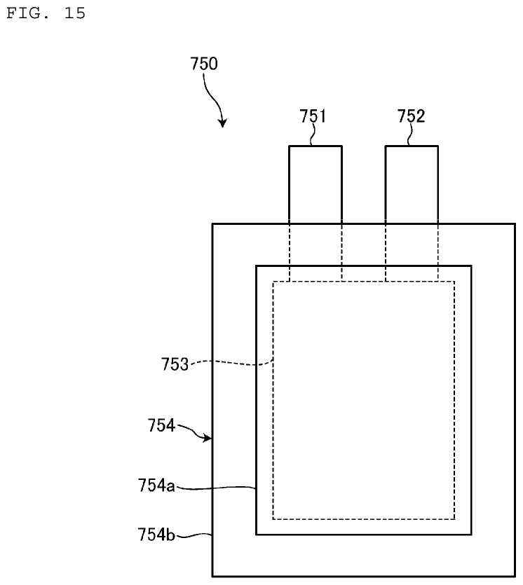

FIG. 15 is a plan view of the battery 750 shown in FIG. 14. The battery 750 has a rectangular shape in plan view. The battery 750 includes a positive electrode terminal 751, a negative electrode terminal 752, a laminated body 753, and an exterior body 754 that houses the laminated body 753.

The laminated body 753 includes a plurality of sheet-like positive electrodes (not shown) and a plurality of sheet-like negative electrodes (not shown), and the positive electrode and the negative electrode are alternately stacked with a separator (not shown) interposed therebetween.

The positive electrode terminal 751 is electrically connected to the plurality of positive electrodes. A part of the positive electrode terminal 751 is located outside the exterior body 754. The negative electrode terminal 752 is electrically connected to the plurality of negative electrodes. A part of the negative electrode terminal 752 is located outside the exterior body 754.

The exterior body 754 is formed by bending one film. The exterior body 754 integrally includes a housing portion 754a and a flange portion 754b. The housing portion 754a hoses the laminated body 753 and an electrolyte (for example, a nonaqueous electrolytic solution). The housing portion 754a is a substantially rectangular parallelepiped. The flange portion 754b is located around the housing portion 754a.

The heat absorbing member 770 shown in FIG. 14 has a substantially rectangular parallelepiped shape. The heat absorbing member 770 includes a heat absorbing agent 771 and an exterior member 772.

The holder 780 shown in FIGS. 13 and 14 includes one holder member 790. The outer shape of the holder member 790 is a rectangular parallelepiped shape. The holder member 790 includes five space portions R arranged along the Z direction. The space portion R is a space that is opened on the −Y side.

One battery 750 and one heat absorbing member 770 are housed in each of the five space portions R in a state where a first battery surface Se1 of the battery 750 and a first heat absorbing surface Sh1 of the heat absorbing member 770 are in contact with each other. The first battery surface Se1 is a +Z-side surface of an outer surface of a battery 650 housed in the space portion R, and corresponds to a part of the outer surface of the housing portion 754a. The first heat absorbing surface Sh1 is a −Z-side surface of an outer surface of the heat absorbing member 770 housed in the space portion R.

In the space portion R, the flange portion 754b is bent. An inner surface 791a of the holder member 790 on the −Z side of the space portion R is in contact with a second battery surface Se2 of the battery 750. The second battery surface Se2 is a surface opposite to the first battery surface Se1 on the outer surface of the battery 650 housed in the space portion R. An inner surface 791a of the holder member 790 on the −Z side of the space portion R corresponds to a contact surface St.

An inner surface 791b of the holder member 790 on the +Z side of the space portion R is in contact with a second heat absorbing surface Sh2 of the heat absorbing member 770. The second heat absorbing surface Sh2 is a +Z-side surface of the outer surface of the heat absorbing member 770 housed in the space portion R, and is a surface opposite to the first heat absorbing surface Sh1.

An inner surface 791c of the holder member 790 on the +Y side of the space portion R is in contact with a third heat absorbing surface Sh3 of the heat absorbing member 770. The third heat absorbing surface Sh3 is a surface on the +Y side of the outer surface of the heat absorbing member 770 housed in the space portion R, and is a surface connecting the first heat absorbing surface Sh1 and the second heat absorbing surface Sh2. The inner surface 791b of the holder member 790 on the +Z side of the space portion R and the inner surface 791c of the holder member 790 on the +Y side of the space portion R correspond to a facing surface So facing the heat absorbing member 770.

One of the inner surface 791b of the holder member 790 on the +Z side of the space portion R and the inner surface 791c of the holder member 790 on the +Y side of the space portion R may be in contact with one heat absorbing member 770. The space portion R may be a space opened on both sides in the Y direction. In this case, the holder member 790 does not have the inner surface 791c on the +Y side of the space portion R.

In the battery pack 1 of the sixth embodiment, the heat absorbing agent 771 leaking from the heat absorbing member 770 reaches the facing surface So, spreads over the holder member 790 through continuous pores Hs, and absorbs heat of the battery 750 similarly to the first embodiment. Therefore, the heat absorption efficiency of the heat absorbing agent 771 can be improved.

Next, a battery pack 1 according to a seventh embodiment of the present disclosure will be described mainly with respect to portions different from those of the sixth embodiment.

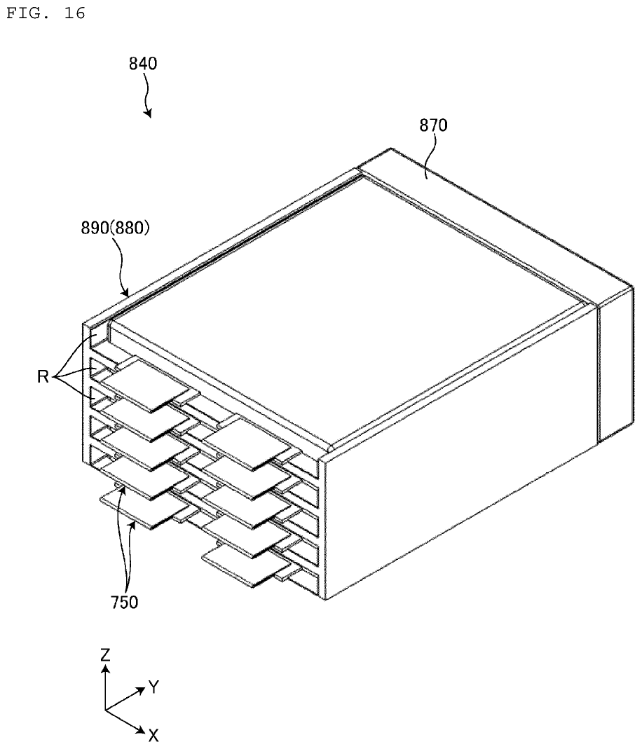

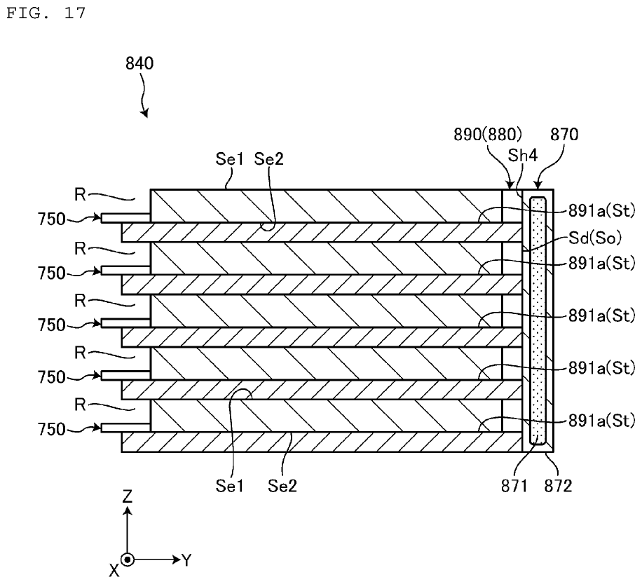

FIG. 16 is a perspective view of a battery unit 740 according to the seventh embodiment of the present disclosure. FIG. 17 is a view showing a sectional shape of a battery unit 840 shown in FIG. 16 taken along a plane orthogonal to the X direction.

In the battery unit 840 of the seventh embodiment, the number and arrangement of the heat absorbing members 870, and the shape of the holder 880 are mainly different from those of the sixth embodiment. The battery unit 840 of the seventh embodiment includes a plurality of batteries 750, one heat absorbing members 870, and the holder 880. In the seventh embodiment, the number of the batteries 750 is five. It goes without saying that the number of batteries 750 and the number of the heat absorbing members 870 are not limited to the above numbers.

The holder member 890 includes five space portions R arranged along the Z direction. The space portion R is a space opened on both sides in the Y direction. The space portion R closest to the +Z side is opened on the +Z side.

One battery 750 is housed in each of the five space portions R. Specifically, an inner surface 891a of the holder member 890 on the −Z side of the space portion R is in contact with a second battery surface Se2 of the battery 750. That is, the inner surface 891a of the holder member 890 on the −Z side of the space portion R corresponds to a contact surface St.

The heat absorbing member 870 includes a heat absorbing agent 871 and an exterior member 872. The heat absorbing member 870 has a substantially rectangular parallelepiped shape. The heat absorbing member 870 is disposed on a predetermined surface Sd on the +Y side of an outer surface of the holder member 890. A fourth heat absorbing surface Sh4 on the −Y side of an outer surface of the heat absorbing member 870 is in contact with the entire predetermined surface Sd. That is, the predetermined surface Sd corresponds to a facing surface So facing the outer surface of the heat absorbing member 870. In addition, the five space portions R is opened on the predetermined surface Sd. Accordingly, the heat absorbing member 870 faces each of the plurality of batteries 750. The heat absorbing member 870 and the plurality of batteries 750 are away from each other. The predetermined surface Sd is not subjected to sealing hole treatment. That is, a pore H is opened in the predetermined surface Sd.

In the battery pack 1 of the seventh embodiment, the heat absorbing agent 871 leaking from the heat absorbing member 870 reaches the facing surface So, spreads over the holder member 890 through continuous pores Hs, and absorbs heat of the battery 750 similarly to the sixth embodiment. Therefore, the heat absorption efficiency of the heat absorbing agent 871 can be improved.

The heat absorbing member 870 and the plurality of batteries 750 may be in contact with each other. In this case, the heat of the battery 750 is easily transferred to the heat absorbing member 870 at the time of abnormal heat generation of the battery 750, and the heat absorbing member 870 is cleaved early. Thus, the heat of the battery 750 can be absorbed early.

Note that the above-described embodiments and modifications are for facilitating understanding of the present disclosure, and are not intended to limit and interpret the present disclosure. The present disclosure may be modified/improved without departing from the spirit thereof, and the present disclosure includes equivalents thereof.

Note that the present disclosure may be a combination of the following configurations according to an embodiment.
(1)

A battery pack including:
a plurality of batteries;
a heat absorbing agent;
a heat absorbing member that houses the heat absorbing agent; and
a holder that holds the plurality of batteries and the heat absorbing member,
wherein
the holder includes a holder member having a facing surface facing an outer surface of the heat absorbing member, the holder member is a porous body having a continuous pore in which a plurality of pores are continuous, and
at least one pore of the plurality of pores included in the continuous pore is opened in the facing surface.
(2)

The battery pack according to (1), wherein the holder member further includes
a contact surface with which an outer surface of one battery of the plurality of batteries is in contact, and
a first communication path that has a first end opened to the facing surface and a second end opened to the contact surface and is formed by the continuous pore.
(3)

The battery pack according to (1) or (2), wherein the holder member further includes a second communication path in which the first end and the second end are opened at positions different from each other on the contact surface and which is formed by the continuous pore.
(4)

The battery pack according to any one of (1) to (3), wherein
the plurality of batteries each have a cylindrical shape, and include a first battery, a second battery, a third battery, and a fourth battery in which center axes of the battery are parallel to each other,
in a sectional shape taken along a plane orthogonal to the center axis,
   the first battery, the second battery, the third battery, and the fourth battery surround the heat absorbing member,
   the holder member further includes a first contact surface in contact with an outer peripheral surface of the first battery, a second contact surface in contact with an outer peripheral surface of the second battery, a third contact surface in contact with an outer peripheral surface of the third battery, and a fourth contact surface in contact with the fourth battery, and
   the facing surface is between two batteries adjacent to each other among the first battery, the second battery, the third battery, and the fourth battery.
(5)

The battery pack according to (4), wherein the outer surface of the heat absorbing member is in contact with each of the outer peripheral surface of the first battery, the outer peripheral surface of the second battery, the outer peripheral surface of the third battery, and the outer peripheral surface of the fourth battery.
(6)

The battery pack according to (4), wherein in the sectional shape,
the first contact surface is in contact with the outer peripheral surface of the first battery over an entire circumference,
the second contact surface is in contact with the outer peripheral surface of the second battery over the entire circumference,
the third contact surface is in contact with the outer peripheral surface of the third battery over the entire circumference,
the fourth contact surface is in contact with the outer peripheral surface of the fourth battery over the entire circumference, and
the facing surface is in contact with an outer peripheral surface of the heat absorbing member over the entire circumference.
(7)

The battery pack according to (4), wherein
an outer surface of the heat absorbing member has a first surface, a second surface, and a third surface,
in the sectional shape,
   the first battery, the second battery, the third battery, and the fourth battery surround the two heat absorbing members,
   one heat absorbing member of the two heat absorbing members is in contact with the outer peripheral surface of the fourth battery on the first surface and is in contact with the outer peripheral surface of the first battery on the second surface,
   another heat absorbing member of the two heat absorbing members is in contact with the outer peripheral surface of the second battery on the first surface and in contact with the outer peripheral surface of the third battery on the second surface, and
   the third surfaces of the two heat absorbing members are in contact with each other.
(8)

The battery pack according to any one of (1) to (7), wherein a material of the holder member is a foamed resin.
(9)

The battery pack according to any one of (1) to (8), wherein
the holder further includes an outer layer disposed on an outer surface of the holder member, and
the outer layer covers a pore opened in an outer surface of the holder member among the plurality of pores, and has rigidity higher than rigidity of the holder member.
(10)

The battery pack according to any one of (1) to (9), wherein the facing surface is in contact with the outer surface of the heat absorbing member.
(11)

The battery pack according to any one of (1) to (3), wherein
each of the plurality of batteries has a cylindrical shape, and includes a first battery and a second battery that are arranged in a row along a direction orthogonal to a center axis of the battery and are adjacent to each other,
in a sectional shape taken along a plane orthogonal to the center axis,
   the holder member has a first contact surface that is in contact with an outer peripheral surface of the first battery over an entire circumference and a second contact surface that is in contact with an outer peripheral surface of the second battery over the entire circumference, and
   the facing surface is on a side opposite to the first contact surface and the second contact surface, and is in contact with the outer surface of the heat absorbing member.
(12)

The battery pack according to any one of (1) to (3), further including a plurality of the heat absorbing members,
wherein
each of the outer surfaces of the plurality of batteries includes a first battery surface,
each of the outer surfaces of the plurality of heat absorbing members includes a first heat absorbing surface and a second heat absorbing surface on a side opposite to the first heat absorbing surface,
the holder member includes a plurality of space portions,
one battery of the plurality of batteries and one heat absorbing member of the plurality of heat absorbing members are housed in the space portion in a state where the first battery surface of the one battery and the first heat absorbing surface of the one heat absorbing member are in contact with each other, and
the facing surface is in contact with the second heat absorbing surface of the one heat absorbing member.
(13)

The battery pack according to any one of (1) to (3), wherein
the holder member includes a plurality of space portions,
one battery of the plurality of batteries is housed in the space portion,
the space portion is opened on a predetermined surface of an outer surface of the holder member, and
the heat absorbing member is disposed on the predetermined surface and faces the one battery.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A battery pack comprising:
a plurality of batteries;
a heat absorbing agent;
a heat absorbing member that houses the heat absorbing agent; and
a holder that holds the plurality of batteries and the heat absorbing member, wherein the holder includes a holder member having a facing surface facing an outer surface of the heat absorbing member, the holder member is a porous body having a continuous pore in which a plurality of pores are continuous, and at least one pore of the plurality of pores included in the continuous pore is opened in the facing surface.

2. The battery pack according to claim 1, wherein the holder member further includes a contact surface with which an outer surface of one battery of the plurality of batteries is in contact, and first communication path that has a first end opened to the facing surface and a second end opened to the contact surface and is formed by the continuous pore.

3. The battery pack according to claim 2, wherein the holder member further includes a second communication path in which the first end and the second end are opened at positions different from each other on the contact surface and which is formed by the continuous pore.

4. The battery pack according to claim 1, wherein the plurality of batteries each have a cylindrical shape, and include a first battery, a second battery, a third battery, and a fourth battery in which center axes of the battery are parallel to each other, in a sectional shape taken along a plane orthogonal to the center axis, the first battery, the second battery, the third battery, and the fourth battery surround the heat absorbing member, the holder member further includes a first contact surface in contact with an outer peripheral surface of the first battery, a second contact surface in contact with an outer peripheral surface of the second battery, a third contact surface in contact with an outer peripheral surface of the third battery, and a fourth contact surface in contact with the fourth battery, and the facing surface is between two batteries adjacent to each other among the first battery, the second battery, the third battery, and the fourth battery.

5. The battery pack according to claim 4, wherein the outer surface of the heat absorbing member is in contact with each of the outer peripheral surface of the first battery, the outer peripheral surface of the second battery, the outer peripheral surface of the third battery, and the outer peripheral surface of the fourth battery.

6. The battery pack according to claim 4, wherein in the sectional shape, the first contact surface is in contact with the outer peripheral surface of the first battery over the entire circumference, the second contact surface is in contact with the outer peripheral surface of the second battery over the entire circumference, the third contact surface is in contact with the outer peripheral surface of the third battery over the entire circumference, the fourth contact surface is in contact with the outer peripheral surface of the fourth battery over the entire circumference, and the facing surface is in contact with an outer peripheral surface of the heat absorbing member over the entire circumference.

7. The battery pack according to claim 4, wherein an outer surface of the heat absorbing member has a first surface, a second surface, and a third surface, in the sectional shape, the first battery, the second battery, the third battery, and the fourth battery surround the two heat absorbing members, one heat absorbing member of the two heat absorbing members is in contact with the outer peripheral surface of the fourth battery on the first surface and is in contact with the outer peripheral surface of the first battery on the second surface, another heat absorbing member of the two heat absorbing members is in contact with the outer peripheral surface of the second battery on the first surface and in contact with the outer peripheral surface of the third battery on the second surface, and the third surfaces of the two heat absorbing members are in contact with each other.

8. The battery pack according to claim 1, wherein a material of the holder member is a foamed resin.

9. The battery pack according to claim 1, wherein the holder further includes an outer layer disposed on an outer surface of the holder member, and the outer layer covers a pore opened in an outer surface of the holder member among the plurality of pores, and has rigidity higher than rigidity of the holder member.

10. The battery pack according to claim 1, wherein the facing surface is in contact with the outer surface of the heat absorbing member.

11. The battery pack according to claim 1, wherein each of the plurality of batteries has a cylindrical shape, and includes a first battery and a second battery that are arranged in a row along a direction orthogonal to a center axis of the battery and are adjacent to each other, in a sectional shape taken along a plane orthogonal to the center axis, the holder member has a first contact surface that is in contact with an outer peripheral surface of the first battery over an entire circumference and a second contact surface that is in contact with an outer peripheral surface of the second battery over the entire circumference, and the facing surface is on a side opposite to the first contact surface and the second contact surface, and is in contact with the outer surface of the heat absorbing member.

12. The battery pack according to claim 1, further comprising a plurality of the heat absorbing members, wherein each of the outer surfaces of the plurality of batteries includes a first battery surface, each of the outer surfaces of the plurality of heat absorbing members includes a first heat absorbing surface and a second heat absorbing surface on a side opposite to the first heat absorbing surface, the holder member includes a plurality of space portions, one battery of the plurality of batteries and one heat absorbing member of the plurality of heat absorbing members are housed in each of the space portions in a state where the first battery surface of the one battery and the first heat absorbing surface of the one heat absorbing member are in contact with each other, and the facing surface is in contact with the second heat absorbing surface of the one heat absorbing member.

13. The battery pack according to claim 1, wherein the holder member includes a plurality of space portions, one battery of the plurality of batteries is housed in each of the space portions, the space portion is opened on a predetermined surface of an outer surface of the holder member, and the heat absorbing member is disposed on the predetermined surface and faces the one battery.
